(19) United States
(12) Patent Application Publication
(10) Pub. No.: US 2011/0204964 A1
(43) Pub. Date: Aug. 25, 2011

(54) LEAKAGE CURRENT CONTROL CIRCUIT

(76) Inventors: Jian Xu, Windsor (CA); John Berard Finch, Linvonia, MI (US)

(21) Appl. No.: 12/709,545

(22) Filed: Feb. 22, 2010

(51) Int. Cl. G05F 1/10

(52) U.S. Cl. 327/543

(57) ABSTRACT

A leakage current control circuit includes a solid state switch that is operable to control a flow of AC to a load. The switch exhibits an AC leakage current in an OFF state. A capacitor is connected in parallel to the load, and is operable to repeatedly charge during a first half cycle of the leakage current and to discharge during a second half cycle of the leakage current. The capacitor charge includes a DC component in response to the leakage current through the solid state switch being greater in a first direction than in a second direction opposite the first direction. A first resistor is connected in parallel to the load. The capacitor and the first resistor prevent a voltage buildup across the load from exceeding a voltage threshold.

### BACKGROUND

This application relates to leakage current, and more particularly to a leakage current control circuit.

Solid state switches are known to permit a certain amount of leakage current to flow through the switch even when the switch is in an OFF state. This can create potentially hazardous conditions if the solid state switch is controlling a flow of current to a lighting fixture because one who inserts a light bulb into the light fixture may become a discharge path for a parasitic capacitance built up around the light fixture. Previous circuits have addressed this issue by using an air gap switch, which physically separates two contacts to create an air gap to prevent any current from passing between the contacts.

### SUMMARY

A leakage current control circuit includes a solid state switch that is operable to control a flow of AC to a load. The switch exhibits an AC leakage current in an OFF state. A capacitor is connected in parallel to the load, and is operable to repeatedly charge during a first half cycle of the leakage current and to discharge during a second half cycle of the leakage current. The capacitor charge includes a DC component in response to the leakage current through the solid state switch being greater in a first direction than in a second direction opposite the first direction. A first resistor is connected in parallel to the load. The capacitor and the first resistor prevent a voltage buildup across the load from exceeding a voltage threshold.

A method of controlling leakage current receives an AC leakage current though a solid state switch in an OFF state, the switch being operable to control a flow of AC to a load. A capacitor is repeatedly charged during a first half cycle of the AC leakage current and discharged during a second half cycle of the AC leakage current, and current is passed through a resistor connected in parallel to the capacitor and connected in parallel to the load to prevent a voltage buildup across the load from exceeding a voltage threshold.

These and other features of the present invention can be best understood from the following specification and drawings, the following of which is a brief description.

### BRIEF DESCRIPTION OF THE DRAWINGS

FIG. 1 schematically illustrates a leakage current control circuit.

FIG. 2 schematically illustrates a multi-channel power controller including the leakage current control circuit of FIG. 1.

### DETAILED DESCRIPTION

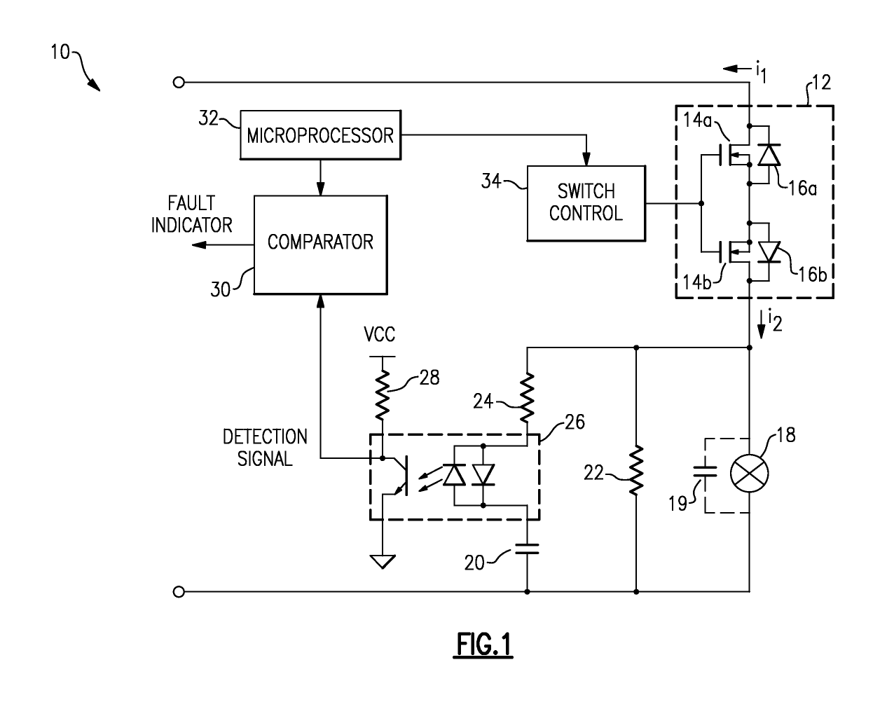

FIG. 1 schematically illustrates a leakage current control circuit 10. The circuit 10 includes a solid state bi-directional switch 12. The switch 12 includes a first MOSFET 14a that has a first body diode 16a, and a second MOSFET 14b that has a second body diode 16b. The body diodes 16a-b schematically represent a behavior of the switch 12, and are not standalone components. The switch 12 is ON when the MOSFETS 14a-b are ON, and is OFF when the MOSFETS 14a-b are OFF. The body diodes 16a-b are oriented to prevent a flow of current from passing through the switch 12 when the switch 12 is OFF. However, despite this orientation a leakage current (see i₁, i₂) still flows through the switch 12 when the switch 12 is OFF. Although the switch 12 is illustrated as being MOSFET-implemented, it is understood that this is only an example, and that other bi-directional solid state switches could be used.

The switch controls a flow of alternating current (“AC”) to a load 18. In one example the load 18 is a lighting load, such as a light fixture, that exhibits a parasitic capacitance 19 when the switch 12 is OFF and no lighting source (e.g. light bulb) is received into the light fixture. The parasitic capacitance 19 is not a standalone component, but represents the parasitic capacitance exhibited by the load 18. The parasitic capacitance 19 can lead to a voltage buildup around the load 18. A capacitor 20 and a resistor 22 are operable to prevent this voltage buildup from exceeding a predefined voltage threshold. In one example the voltage threshold may be 20 Volts. Of course, this is only an example and other voltage thresholds could be used.

The capacitor 20 is connected in parallel to the load 18. The capacitor 20 is operable to repeatedly charge during a first half cycle the leakage current and to discharge during a second half cycle of the leakage current. If one of the leakage current values i₁, i₂ is greater than the other of the leakage current values i₁, i₂ such that i₁≠i₂, there will be a net leakage current, and the capacitor 20 will accumulate a charge such that the voltage buildup around the load 18 does not exceed the predefined voltage threshold. The capacitor limits an AC component of the voltage buildup such that a larger capacitance yields a smaller AC component, and a smaller capacitance yields a larger AC component.

The resistor 22 is connected in parallel to the load 18 and to the capacitor 20 and is operable to limit a direct current (“DC”) component of the voltage buildup, and consequently of the capacitor 20 charge. The resistor 22 having a larger resistance yields a larger DC component, and the resistor 22 having smaller resistance yields a smaller DC component. The resistor 22 may be selected to have a magnitude such that if there is no net leakage current (i.e. i₁=i₂), only a negligible amount of current flows through the resistor 22, and if there is a net leakage current (i.e. i₁≠i₂) the DC component of the voltage buildup is limited through the resistor 22.

The circuit 10 further includes a resistor 24 and an optocoupler 26 connected in series with the capacitor 20. The resistor 24 acts as a current limiting resistor by limiting an amount of current that passes through capacitor 20. The optocoupler 26 is operable to indicate a potential fault condition. Some example fault conditions include the leakage current exceeding a predefined threshold, or the switch 12 being shorted ON.

A resistor 28 is connected to an output of the optocoupler 26 and is connected to a comparator 30. The resistor 28 generates a logic high signal (“1”) when the optocoupler 26 is OFF. The resistor 28 generates a logic low signal (“0”) when the optocoupler 26 is ON, as the optocoupler 26 being ON shorts the resistor 28 to ground. Comparator 30 is operable to receive the logic signal from the resistor 28 and is operable to transmit a fault indication in response to the second logic signal being a “0.”

A microprocessor 32 is operable to receive the potential fault indication. In one example, if a fault notification is received and the switch 12 is ON then the potential fault indication is ignored, and if a potential fault notification is received and the switch 12 is OFF then the potential fault condition is treated as an actual fault condition. The microprocessor 32 is operable command the solid state switch 12 to turn ON or OFF via switch control 34.

In one example, the resistors 24, 28 are chosen to have resistance values that are less than a resistance of the resistor 22. In one example, resistor 22 has a resistance of 1 MΩ, resistor 24 has a resistance of 2.6 kΩ, resistor 28 has a resistance of 1.5 kΩ, and capacitor 20 has a capacitance of 0.1 uF. Of course these values are only examples, and it is understood that other resistance and capacitance values could be used.

If one was to deal with the voltage buildup related to the parasitic capacitance 19 by simply placing a resistor across the load 18 (e.g. a 10-40 kΩ resistor), the voltage buildup from a leakage current though switch 12 would be limited, but large amounts of heat would be generated when the switch 12 and load 18 were actually ON. The leakage current control circuit 10 handles the voltage buildup much more efficiently, dissipating less heat and using less energy when the switch 12 and load 18 are ON than would otherwise be the case if one used the single resistor solution described above, because in the circuit 10 one is able to use a capacitor to limit the AC component of the charge and a larger resistor (e.g. a 1 MΩ resistor) to limit the DC component of the charge.

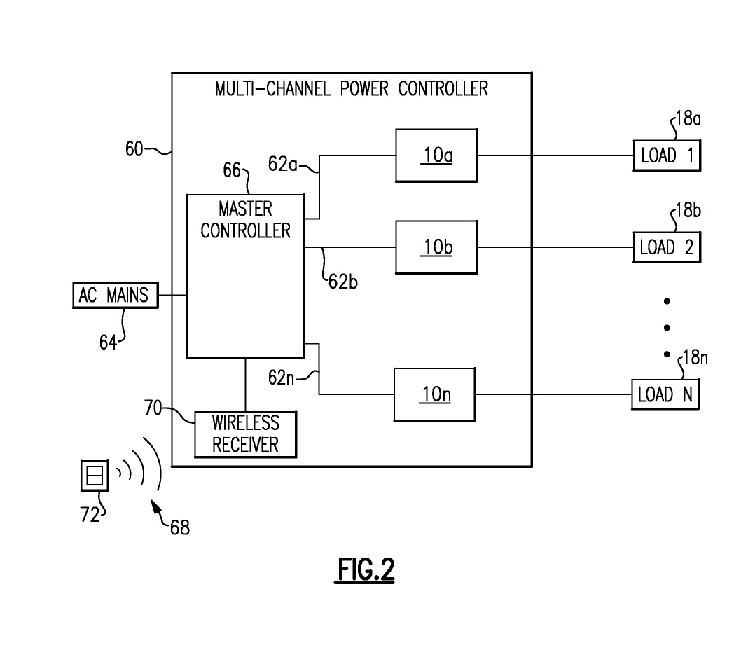

FIG. 2 schematically illustrates a multi-channel power controller 60 including the leakage current circuit of FIG. 1. The controller 60 is includes a plurality of power control channels 62a-n, each of which controls a flow of AC from AC mains 64 to a load 18a-n, and each of which includes the leakage current control circuit 10a-n. A master controller 66 is in communication with each of the leakage current control circuits 10. In one example the master controller 66 is operable to control the microprocessor 32 included in each leakage current control circuit 10. The controller 66 is responsive to wireless signals 68 received by a wireless receiver 70. The wireless signals 68 may be transmitted by a batteryless, self-energizing switch 72. Although a multi-channel power controller 60 has been described, it is understood that the power controller 60 is only an example application for the leakage control circuit 10, and other applications for the leakage current control circuit 10 would be possible.

Although a preferred embodiment has been disclosed, a worker of ordinary skill in this art would recognize that certain modifications would come within the scope of this invention. For that reason, the following claims should be studied to determine the true scope and content of this invention.

What is claimed is:

1. A leakage current control circuit, comprising:
a solid state switch operable to control a flow of AC to a load, the switch exhibiting an AC leakage current in an OFF state;
a capacitor connected in parallel to the load, the capacitor being operable to repeatedly charge during a first half cycle of the leakage current and to discharge during a second half cycle of the leakage current, the capacitor charge including a DC component in response to the leakage current through the solid state switch being greater in a first direction than in a second direction opposite the first direction; and
a first resistor connected in parallel to the load, the capacitor and the first resistor preventing a voltage buildup across the load from exceeding a voltage threshold.

2. The circuit of claim 1, wherein the load is a lighting fixture having a parasitic capacitance when the solid state switch is in the OFF state and no lighting source is received into the light fixture, and wherein the voltage buildup is a parasitic capacitance voltage buildup.

3. The circuit of claim 1, wherein the capacitor is repeatedly charged during a first half cycle of the leakage current and discharged during a second half cycle of the leakage current in response to the leakage current through the solid state switch being greater in a first direction than in a second direction opposite the first direction.

4. The circuit of claim 1, wherein the capacitor limits an AC component of the voltage buildup and the first resistor limits a DC component of the voltage buildup.

5. The circuit of claim 4, the capacitor having a capacitance and the first resistor having a resistance, wherein a larger capacitance permits a smaller AC component, a smaller capacitance permits a larger AC component, a larger resistance permits a larger DC component, and a smaller resistance permits a smaller DC component.

6. The circuit of claim 1, the first resistor having a first resistance, the voltage control circuit including:
a second resistor connected in series with the capacitor, the second resistor having a second resistance less than the first resistance.

7. The circuit of claim 6, wherein the second resistor limits an amount of current that passes through the capacitor.

8. The circuit of claim 6, including:
an optocoupler connected in series with the second resistor and the capacitor, the optocoupler being operable to indicate a potential fault condition in response to the leakage current exceeding a predefined threshold or in response to the solid state switch being shorted ON.

9. The circuit of claim 8, including:
a third resistor connected to an output of the optocoupler, the third resistor being selected to generate a first logic signal when the optocoupler is OFF, and to generate a second logic signal opposite the first logic signal when the optocoupler is ON, the second logic signal indicating a potential fault condition.

10. The circuit of claim 9, including:
a microprocessor operable to command the solid state switch to turn ON or OFF; and
a comparator in communication with the microprocessor, the comparator being operable to receive the first or second logic signal, and being operable to indicate an actual fault indication in response to the solid state switch being in the OFF state and the second logic signal indicating a potential fault condition.

11. The circuit of claim 1, wherein the solid state switch is a MOSFET bi-directional switch.

12. A method of controlling leakage current, comprising:
A) receiving an AC leakage current though a solid state switch in an OFF state, the switch being operable to control a flow of AC to a load;
B) repeatedly charging a capacitor during a first half cycle of the AC leakage current and discharging the capacitor during a second half cycle of the AC leakage current; and
C) passing current through a resistor connected in parallel to the capacitor and connected in parallel to the load, wherein steps (B)-(C) prevent a voltage buildup across the load from exceeding a voltage threshold.

13. The method of claim 12, wherein said steps (B)-(C) are performed in response to the leakage current through the solid state switch being greater in a first direction than in a second direction opposite the first direction.

14. The method of claim 12, wherein the load is a lighting fixture having a parasitic capacitance when the solid state switch is OFF and no lighting source is received into the light fixture, and wherein the voltage buildup is a parasitic capacitance voltage buildup.

15. The method of claim 12, including:
selecting the resistor to limit a DC component of the voltage buildup, such that a larger resistance permits a larger DC component and a smaller resistance permits a smaller DC component.

16. The method of claim 12, including:
selecting the capacitor to limit an AC component of the voltage buildup such that a larger capacitance permits a smaller AC component, a smaller capacitance permits a larger AC component.

17. The method of claim 12, including:
producing an output signal from an optocoupler to indicate a potential fault condition in response to the leakage current exceeding a predefined threshold.

18. The method of claim 12, the resistor being a first resistor having a first resistance, the method including:
connecting a second resistor in series with the capacitor to limit an amount of current that passes through the capacitor.

19. The method of claim 18, including:
connecting the optocoupler in series with the second resistor and the capacitor.
